(19) United States
(12) Patent Application Publication
(10) Pub. No.: US 2015/0096392 A1
(43) Pub. Date: Apr. 9, 2015

(54) ACTUATOR HAVING AN OFFSET MOTOR USING A FLEXIBLE TRANSMISSION, AND ROBOTIC ARM USING SUCH AN ACTUATOR

(71) Applicant: Philippe Garrec, Gif-sur-Yvette (FR)

(72) Inventor: Philippe Garrec, Gif-sur-Yvette (FR)

(73) Assignee: COMMISSARIAT A L'ENERGIE ATOMQUE ET AUX ENERGIES ALTRNATIVES, Paris (FR)

(21) Appl. No.: 14/396,601

(22) PCT Filed: Apr. 26, 2013
(86) PCT No.: PCT/EP2013/058720

§ 371 Date: Oct. 23, 2014

(30) Foreign Application Priority Data
May 9, 2012 (FR) 1254237

(51) Int. Cl. F16H 25/20; F16C 1/06; F16C 1/28; B25J 18/00

(52) U.S. Cl. CPC F16H 25/20; B25J 18/00; F16C 1/06; F16C 1/28; F16H 2025/2062; Y10S 901/21; Y10S 901/25
USPC 74/89.23; 901/21; 901/25

(57) ABSTRACT

The invention concerns a flexible transmission (1 and 1′) intended to be disposed between a motor member imposing a rotation movement and a receiving member receiving the rotation movement via the flexible transmission, the transmission comprising a flexible sheath (2) in which a flexible shaft (3) extends, bearings (4) with rolling elements being regularly interposed between the flexible sheath and the flexible shaft to guide the latter in rotation in the flexible sheath. The invention also concerns robotic arms provided with such a flexible transmission, and a cable actuator having a motor offset using such a flexible transmission.

The invention relates to a cable cylinder with an offset motor using a flexible transmission, and to a robotized arm using such a cylinder.

### BACKGROUND OF THE INVENTION

Flexible transmissions generally comprise a flexible transmission shaft which extends through a sheath, which is also flexible. The ends of the flexible shaft are attached on the one hand to a motor component capable of making the shaft rotate, and on the other hand to a receiving component which utilizes the rotation of the flexible shaft. Such transmissions are generally used when a relative movement between the motor component and the receiving component is envisioned. The sliding contact between the shaft and the sheath leads to sliding friction which is high and furthermore variable with the radius of curvature, even when a lubricant is used.

Flexible transmissions comprising a flexible shaft extending through a flexible sheath are known, the shaft having ends linked to end-pieces which are guided in rotation by ball bearings interposed between each end-piece and the sheath. The use of ball bearings for guiding the ends improves the efficiency of the assembly, which, however, still suffers from friction between the shaft and the sheath.

Furthermore, Document U.S. Pat. No. 4,424,045 discloses a rigid-sheath transmission composed of successive curved segments which can be oriented with respect to one another. The sheath receives a flexible shaft which is guided by bearings made of plastic material, for example polyimide resin, these being arranged at each connection between two successive segments. The rigid sheath does not allow movements between the motor component and the receiving component to be followed. Furthermore, sliding friction acts between the bearings and the shaft, which again leads to poor efficiency.

Document FR 551944 discloses flexible transmissions intended to be arranged between a motor component imparting a rotational movement and a receiving component receiving the rotational movement via the flexible transmission, such transmissions comprising a flexible sheath which receives a flexible shaft with rolling-element bearings regularly interposed between the flexible sheath and the flexible shaft in order to guide the latter in rotation in the sheath.

Of course, the sheath is sufficiently flexible to follow the relative movements between the motor component and the receiving component, but is nevertheless sufficiently rigid to impose its curvature on the flexible shaft through the bearings.

The transmission of the invention combines both flexibility and friction which is low (high efficiency) and regular, and which depends very little on the radius of curvature, which allows possible compensation through the controlling of the actuator which is equipped with it. Naturally, arrangements will be made to space the bearings apart in such a way that the flexible shaft portion between two successive bearings cannot either lead to static instability (for example by twisting) or enter an unstable mode in view of the rotational speed imparted to the flexible shaft. Conversely, for a given spacing of the bearings, a critical torque and a maximum rotational speed for which the flexible shaft portions cannot enter an unstable mode will be determined; the two phenomena may lead to the creation of contact points, and therefore an abrupt increase in friction between the flexible shaft and the flexible sheath.

### OBJECT OF THE INVENTION

The object of the invention is to provide a cable cylinder with an offset motor, a flexible transmission with improved efficiency, and a robotized arm.

### SUMMARY OF THE INVENTION

The invention relates to a cable cylinder comprising a tensioned cable and a screwnut assembly, of which one of the elements is attached to the cable and the other of the elements is driven in rotation by a motor component, wherein the motor is connected to the element to be driven by at least one flexible transmission which comprises a flexible sheath in which a flexible shaft extends, rolling-element bearings being regularly interposed between the flexible sheath and the flexible shaft in order to guide the latter in rotation in the flexible sheath while avoiding any contact between the shaft and the sheath.

The invention also relates to a robotized arm comprising at least first, second and third parts articulated to one another, the movement of the third part relative to the second part being actuated by a cable cylinder arranged on the second part, the cable cylinder comprising a motor component arranged on the first part and connected to the cable cylinder by at least one flexible transmission according to the invention.

### BRIEF DESCRIPTION OF THE DRAWINGS

The invention will be better understood on reading the following description with reference to the figures of the appended drawings, in which:

FIG. 1 is a schematic sectional view of a flexible transmission which can be used in the scope of the invention;

FIG. 2 is a schematic view of an application of the flexible transmission of FIG. 1 to the actuation of a segment of a robotized arm;

FIG. 2bis is a detail view of one possible way of mounting the motor component on the robotized arm of FIG. 2;

FIG. 3 is a schematic view of one application of the flexible transmission of FIG. 1 to the actuation of a segment of a robotized arm;

FIG. 4 is a schematic view of another use of the transmission of the invention for the actuation of a segment of a robotized arm, in which two transmissions are coupled in series.

### DETAILED DESCRIPTION OF THE INVENTION

With reference to FIG. 1, the flexible transmission 1 which can be used in the scope of the invention comprises a flexible sheath 2 in which a flexible shaft 3 extends in order to rotate. Rolling-element bearings, here ball bearings 4, are interposed between the flexible shaft 3 and the flexible sheath 2 in order to guide the flexible shaft 3 in rotation and prevent it from touching the flexible sheath 2.

The spacing of the bearings is selected, taking into account the rigidity characteristics of the flexible shaft 3, torque to be transmitted and the maximum rotational speed imposed on the flexible shaft 3, so that the flexible shaft portions 3 extending between two bearings 4 can neither twist nor enter an unstable mode. According to requirements, the ends of the flexible shaft may be made to extend out of the flexible sheath in order to be coupled directly to the motor component and to the receiving component. The ends of the flexible shaft 3 may furthermore be linked in rotation with end-pieces mounted so as to rotate at the ends of the flexible sheath with the aid of rolling-element bearings.

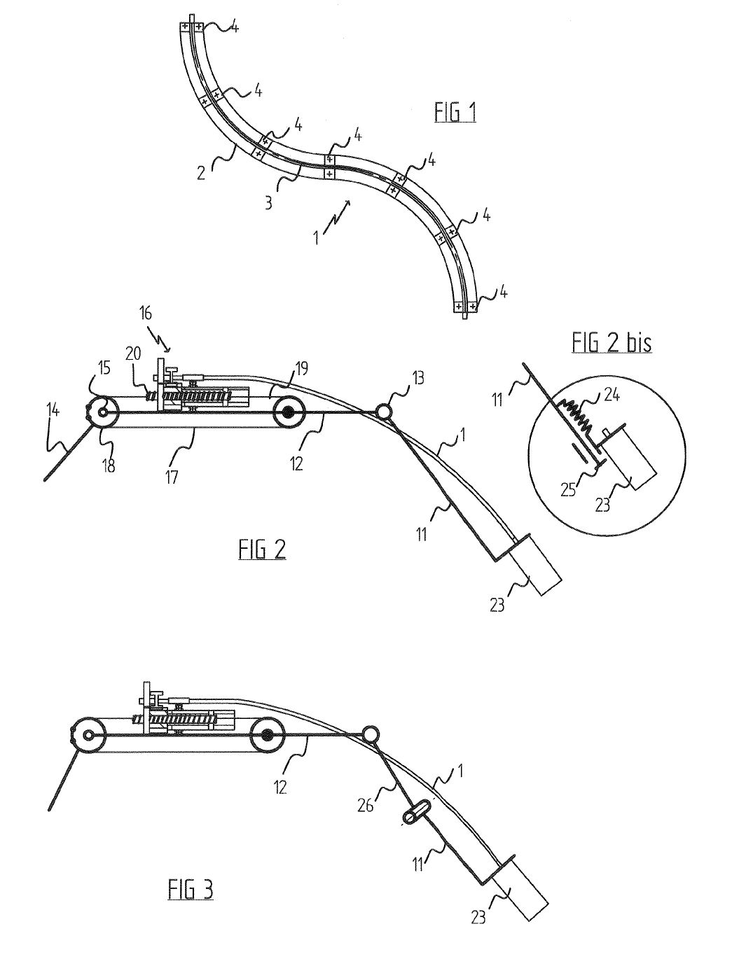

FIG. 2 represents an application of the invention to the actuation of a segment of a robotized arm. The robotized arm 10 illustrated comprises a base 11, on which a first segment 12 is articulated about a pivot connection 13. A second segment 14 is articulated to the end of the first segment 12 by another pivot connection 15. The movements of the second segment 14 with respect to the first segment 12 are actuated by a cable cylinder 16, which comprises a cable 17 mounted endlessly under tension between a pulley 18 pivoting about the axis of the pivot connection 15, while being linked to the second segment 14, and a return pulley 19 mounted so as to rotate on the first segment 12. One of the strands of the cable 17 is linked to a screw 20, which can be displaced axially under the effect of a rotation of an associated nut 21. The nut 21 is provided with teeth in order to be driven in rotation by a toothed wheel 22, which is itself driven by a motor component 23 arranged on the base 11. A flexible transmission according to the invention is installed between the motor component 23 and the toothed wheel 22, in order to allow the toothed wheel 22 to be driven in rotation by the motor component 23. It will be noted that pivoting movements between the motor component 23 and the receiving component, in this case the toothed wheel 22, are allowed by the pivot connection 13.

It will be noted that the motor component 23 is rigidly mounted on the base 11. FIG. 2bis illustrates a mounting variant in which the motor 23 is mounted free to move along an axis X against an elastic restoring force toward a stop 24. This type of mounting makes it possible to accommodate the tension forces which could be imposed on the transmission because of the movements of the first segment 12 relative to the base 11.

Of course, the part of the arm which carries the motor component and the part of the arm which carries the receiving component may be separated from one another by more than one articulation, as in the example illustrated in FIG. 3, in which an intermediate segment 24 is interposed between the base 11 and the first segment 12.

The flexible transmission of the invention makes it possible to offset the motors while maintaining a longitudinal orientation thereof along the portion of the robotized arm which carries the motors. Furthermore, such a transmission may be designed without an operating play, which improves the repeatability of the movement transmission. Furthermore, the inertia introduced by such a transmission is very small compared with the inertia provided by a transmission with a shaft and an angle return. Furthermore, such a transmission has a low cost compared with entirely rigid solutions.

Various application examples of such a flexible transmission in robotics may be mentioned, for example the actuation of a phalange of a finger of a robotized hand by means of a cable cylinder arranged in the palm, the cable cylinder itself being connected to a motor component arranged in the forearm by means of a flexible transmission according to the invention. The actuation of a leg of a lower exoskeleton by means of a cable cylinder arranged on the thigh may also be mentioned, the cable cylinder itself being connected to a motor component arranged in the pelvis of the exoskeleton by means of a flexible transmission according to the invention.

There may be situations in which the distance between the motor component and the receiving component is such that it could make the flexible transmission unstable under the effect of its weight, or alternatively lead to the flexible transmission departing from a given pattern around the segments of the robotized arm during movements of the latter. In this case, supports linked to the various segments of the robotized arm may well be used in order to guide the flexible transmission and make it follow the movements of the robotized arm segments along which the flexible transmission extends. This arrangement, however, imposes stresses on the running part of the flexible sheath, with the risk of giving rise to undesired contacts between the flexible shaft and the flexible sheath.

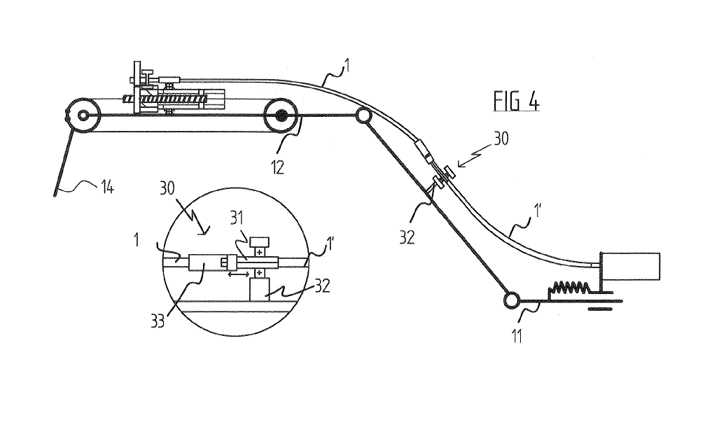

According to a preferred embodiment, in this case a plurality of flexible transitions are used, which are placed in series and connected to one another by a coupling component fixed to the robotized arm. Thus, in the example illustrated in FIG. 4, two flexible transmissions 1 and 1′ are used in order to connect the toothed wheel of a cable cylinder to a motor component. The two flexible transmissions are connected to a coupling component 30 comprising on the one hand a splined shaft 31 mounted so as to rotate on a support 32 linked to the robotized arm, and on the other hand a splined bushing 33 mounted on the splined shaft so as to be able to slide on the latter while being linked in rotation with the splined shaft. Here, the end of the flexible shaft of the flexible transmission 1 is coupled to the bushing 33, while the end of the flexible shaft of the flexible transmission 1′ is coupled to the splined shaft 32. Thus, this coupling makes it possible to limit the length of each flexible transmission used, while leaving axial freedom to accommodate the possible tensions which may affect the flexible transmission 1. Furthermore, the running part of the flexible sheath of each flexible transmission is not subjected to any stress.

The invention is not limited to that which has been described above, but rather covers any variant falling within the scope defined by the claims. In particular, although the bearings of the flexible transmission which is described here are ball bearings, other rolling-element bearings may also be used, for example needle roller bearings, so long as they are compatible with the curvature of the flexible shaft.

Although in this case the cable cylinder using the flexible connection of the invention comprises a cable mounted endlessly under tension between two pulleys, it is of course possible to use the invention with a unilateral-effect cylinder, in which the cable passes around a pulley which thus defines a first cable strand linked to one of the elements of the screwnut assembly, and a second cable strand associated with a return spring so as to be tensioned by said return spring.

1. A cable cylinder comprising a cable and a screwnut assembly, of which one of the elements is attached to the cable and the other of the elements is driven in rotation by a motor component, so that rotation of the rotary element leads to movement of the cable, characterized in that the motor is connected to the element to be driven by at least one flexible transmission which comprises a flexible sheath in which a flexible shaft extends, rolling-element bearings being regularly interposed between the flexible sheath and the flexible shaft in order to guide the latter in rotation in the flexible sheath while avoiding any contact between the shaft and the sheath.

2. The cable cylinder as claimed in claim 1, wherein the cable is tensioned endlessly between two pulleys.

3. The cable cylinder as claimed in claim 1, wherein the cable passes around a pulley which defines a first strand of the cable, attached to one of the elements of the screwnut assembly, and a second strand of the cable associated with a return spring and tensioned by said return spring.

4. A robotized arm comprising at least first, second and third parts articulated to one another, the movement of the third part relative to the second part being actuated by a cable cylinder as claimed in claim 1, arranged on the second part, the motor component of the cable cylinder being arranged on the first part and connected to the cable cylinder by the flexible transmission.

5. The robotized arm as claimed in claim 4, wherein at least two flexible transmissions are arranged in series between the motor component and the receiving component, the two flexible transmissions being coupled by means of a coupling component comprising a splined shaft mounted so as to rotate on a support, and a splined bushing mounted on the splined shaft in order to slide therein while being linked in rotation with the splined shaft, the flexible shaft of one of the flexible transmissions being attached to the splined shaft, while the flexible shaft of the other transmission is attached to the bushing.
